(19) United States
(12) Patent Application Publication
(10) Pub. No.: US 2023/0242846 A1
(43) Pub. Date: Aug. 3, 2023

(54) TABLET

(71) Applicant: Conopco, Inc., d/b/a UNILEVER, Englewood Cliffs, NJ (US)

(72) Inventors: Debosree CHATTERJEE, Bangalore (IN); Ganesan RAJENDIRAN, Bangalore (IN)

(21) Appl. No.: 17/925,894

(22) PCT Filed: May 19, 2021
(86) PCT No.: PCT/EP2021/063299

§ 371 Date: Nov. 17, 2022

(30) Foreign Application Priority Data
May 28, 2020 (IN) 202021022450
Aug. 3, 2020 (EP) 20189265.0

(51) Int. Cl. C11D 17/00; C11D 11/00; C11D 3/00; C11D 3/10; C11D 3/04; C11D 3/37

(52) U.S. Cl. CPC C11D 17/0091; C11D 11/0023; C11D 3/0094; C11D 3/10; C11D 3/046; C11D 3/3776

(57) ABSTRACT

A tablet for forming a liquid dishwash composition on dissolution in water comprising from 0.1 to 40% wt. surfactant, an effervescent, an acid salt selected from sodium bisulphate, monosodium phosphate and mixture thereof, and a disintegrant.

The present invention relates to a tablet for dishwashing, in particular a tablet for forming a liquid cleaning composition for hand dishwashing.

Despite the prior art there remains a need for improved tablets for dishwashing. Consumers expect a tablet to dissolve quickly in water to form a cleaning composition for hand dishwashing. It is also highly desirable that the tablet provides a cue to consumers that dissolution is occurring, and fizzing is a prime performance cue.

Accordingly, and in a first aspect, there is provided a tablet for forming a liquid dishwash composition on dissolution in water comprising:
from 0.1 to 40% wt. surfactant;
an effervescent;
an acid salt selected from sodium bisulphate, monosodium phosphate and mixture thereof; and
a disintegrant.

In a dishwashing context a tablet is a unit dose product which forms a cleaning composition on dissolution in water. Typically, a tablet of this kind comprises surfactant and a disintegrating agent. In use, the consumer drops the tablet in water and agitates the mixture until the tablet is completely dissolved and the dish wash cleaning liquor is formed.

Many consumers like to experience the dissolution of the tablet in water and yet do not want to be stirring the composition by hand for a long period of time before the tablet is fully dissolved and the cleaning composition is ready for use. They look for a cue as to the readiness of the cleaning composition for use. One possible solution is to add an effervescing agent into the tablet. The effervescing agent generates effervescence during dissolution providing a cue to the consumers that the dissolution is occurring. Moreover, as the effervescence is over, it indicates to the consumers that the composition is ready for use. However, it is observed that in presence of the surfactant and the disintegrating agent, conventional effervescing agents are not effective, and rate of effervescence is slow. Thereby, the consumers need to wait for a long period of time before they start using the composition. Hence, it is desirable that the tablet should effervesce quickly, thereby reducing waiting time.

Surprisingly, we have found that the tablet according to the present invention comprising an acid salt, is able to generate fast effervescence in water and able to provide a cue to the consumers about the formation of the cleaning composition.

The present invention provides a tablet for forming a liquid dishwash composition on dissolution in water. The tablet comprises from 0.1 to 40% wt. surfactant, an effervescing agent, an acid salt selected from sodium bisulphate, monosodium phosphate and mixture thereof, and a disintegrating agent.

Preferably the surfactant is present at from 1 to 30% wt. and more preferably from 5 to 25% wt. of the tablet.

Preferably the surfactant is selected from anionic surfactant, non-ionic surfactant and mixture thereof. A preferred anionic surfactant is primary alkyl sulphate.

The effervescing agent generates effervescence during dissolution of the tablet and provides a cue to the consumer. Preferably, the effervescent is present at from 10 to 50% wt. of the tablet. More preferably the effervescent is present at from 15 to 45% wt. and most preferably from 20 to 40% wt. of the tablet.

Preferably the effervescing agent is selected from a carbonate salt, a bicarbonate salt and mixtures thereof. A preferred effervescent is sodium bicarbonate.

The tablet comprises an acid salt for faster effervescence during dissolution of the tablet in water. Acid salts herein refer to a group of salts which form acidic solutions in water. Preferably these are inorganic salts and are formed by incomplete neutralisation of bivalent or trivalent acids.

Preferably the acid salt is present at from 10 to 50% wt. of the tablet. More preferably the acid salt is present at from 15 to 45% wt. and most preferably 20 to 40% wt. of the tablet. Preferably the ratio of the effervescent agent to the acid salt is from 5:1 to 1:5 by weight. More preferably the ratio of the effervescent agent to the acid salt is from 3:1 to 1:3 by weight. A preferred ratio of the effervescent agent to the acid salt is 1:1 by weight. The acid salt is selected from sodium bisulphate, monosodium phosphate and mixture thereof.

Preferably the tablet comprises a disintegrant for enhancing dissolution by disintegrating the tablet in water. Without wishing to be limited by theory it is believed that disintegrants are group of compounds present in tablets, which undergoes physical or chemical changes in contact with water thereby aiding in breaking apart the tablets. Detail about the disintegrants may be found in reference books related to tablet or tablet processing, such as, “Pharmaceutical dosage forms: Tablets” Vol 1, edited by Herbert A Liebermann, Second edition, Marcel Dekker. Inc., 1989 (Chapter 3, Page 159 to 179).

Preferably the disintegrant is present at from 5 to 40% wt. of the tablet. More preferably the disintegrant is present from 10 to 35% wt. and most preferably from 15 to 30% wt. of the tablet.

Preferably the disintegrating agent is selected from polyvinyl pyrrolidone, microcrystalline cellulose and mixture thereof. A preferred disintegrating agent is polyvinyl pyrrolidone.

Accordingly, and in a second aspect, there is provided a method for forming a wash liquor by depositing a tablet according to the first aspect into water and optionally agitating.

Preferably the ratio of the tablet to water for forming the wash liquor varies from 1:10 to 1:100 by weight.

### EXAMPLES

The following are formulations for preparing a tablet composition for forming a hand dishwash composition in use.

TABLE 1

| | Formulation A | Formulation 1 |
|---|---|---|
| Ingredient | (% w/w) | (% w/w) |
| PAS | 15.83 | 15.98 |
| CMEA | 4.95 | 5.00 |
| Sodium bicarbonate | 29.67 | 29.47 |
| Sodium bisulphate | 0 | 29.47 |
| Citric acid | 29.67 | 0 |
| Disintex 75 | 19.78 | 19.98 |
| Silica + Perfume + Dye | 0.1 | 0.1 |

Formulation 1 is a formulation according to invention and formulation A is a comparative. Process for manufacture:

All ingredients were taken as dry powder and were mixed in appropriate weight as per table 1. A measured amount (2.5 gram) of the powder mixture was poured into a mould and pressed using a rotary press or hydraulic press. After some time, the tablet was ejected out of the mould and stored in a container.

Test Methodology for Measuring Disintegration Time:

A tablet weighing 2.5 gram was dropped in a beaker containing 40 millilitre water, thereby the tablet disintegrated to smaller granules and dissolved. Time taken for the tablet to disintegrate to a size of less than 1 millimetre was noted as the disintegration time

Test Methodology for Assessing Fizz:

Fizz was assessed by measuring the amount of foam generated by fizzing of the tablet during dissolution in water. A tablet was dropped in a measuring cylinder containing 50 millilitres water and allowed to fizz. Volume of the foam was measured after 60 seconds. If the foam volume was more than 30 millilitres, it was considered as good fizz. The foam volume of 10 to 30 millilitres was considered as moderate fizz and less than 10 millilitres was considered as poor fizz.

Evaluation of the Formulations:

TABLE 2

| Formulation | Formulation A | Formulation 1 |
|---|---|---|
| Disintegration time (seconds) | 150 | 30 |
| Fizzing | Moderate | Good |

Table 2 shows that formulation 1 takes significantly less time to disintegrate and generates good amount of fizz compared to formulation A. This implies that the formulation 1 dissolves fast generating good amount of effervescence compared to formulation A.

1. A tablet for forming a liquid dishwash composition on dissolution in water comprising:
from 0.1 to 40% wt. surfactant;
an effervescent;
at least 10% wt. of an acid salt selected from sodium bisulphate, monosodium phosphate and mixture thereof; and
a disintegrant.

2. A tablet according to claim 1 wherein the surfactant is selected from anionic surfactants, non-ionic surfactants and mixtures thereof.

3. A tablet according to claim 1 wherein the effervescent is present at from 10 to 50% wt. of the tablet.

4. A tablet according to claim 1 wherein the effervescent is selected from a carbonate salt, a bicarbonate salt and mixtures thereof.

5. A tablet according to claim 1 wherein the acid salt is present at from 10 to 50% wt. of the tablet.

6. A tablet according to claim 1 wherein the ratio of the effervescent to the acid salt is from 5:1 to 1:5 by weight.

7. A tablet according to claim 1 wherein the disintegrant is present at from 5 to 40% wt. of the tablet.

8. A tablet according to claim 1 wherein the disintegrant is selected from polyvinyl pyrrolidone, microcrystalline cellulose and mixture thereof.

9. A tablet according to claim 1 wherein the disintegrant is polyvinyl pyrrolidone.

10. A method for forming a hand dishwash liquor by depositing a tablet according to claim 1 into water.

11. A method according to claim 1 wherein the ratio of the tablet to water is from 1:10 to 1:100 by weight.
